(19) United States
(12) Patent Application Publication
(10) Pub. No.: US 2002/0132093 A1
(43) Pub. Date: Sep. 19, 2002

(54) Luminescent bathroom tissue

(76) Inventor: Todd M. Martin, Fairfax, VA (US)

Correspondence Address: Todd M. Martin, Esq., 2222 Astoria Circle, Herndon, VA, 20170, US

(21) Appl. No.: 09/810,907

(22) Filed: Mar. 15, 2001

(51) Int. Cl. B32B 3/00; B32B 27/14

(52) U.S. Cl. 428/195

(57) ABSTRACT

The present invention relates to a luminescent bathroom tissue that permits users to more easily identify the tissue product under reduced light conditions. A preferred form of the present invention includes the incorporation of a photo-luminescent phosphor as an additive agent in a paper web adapted to absorb moisture.

### FIELD OF THE INVENTION

The present invention relates to bathroom tissue having luminescent properties.

### BACKGROUND OF THE INVENTION

Tissue products, such as bathroom tissue are in widespread use throughout society. Many advancements have been made in the art of tissue paper in terms of durability, softness, and absorbency. However, no features have been developed which would allow a user to more readily identify or recognize the tissue product under reduced light conditions. For example, those in need of a facial tissue in the middle of the night have either had to turn on a light and thus disturb their partner, or have had to keep the facial tissue close at hand, sometimes on the ground beside the bed where a person might easily trip. In other situations, it would be desirable to have a luminescent bathroom tissue so that users may use the product with as little light as that put out by a standard “night-light,” thereby avoiding the temporary blindness experienced by a user when turning on a light in the middle of the night. Consequently, there exists a need for a luminescent tissue product that helps the user more readily recognize the product under reduced light conditions.

Luminescence is the property of a material in which energy that is channeled to a molecule produces an excited state. The return of the molecule to a lower energy state results in the release of a photon, thereby causing the continued emission of visible light after the source of excitation has been removed. Materials that exhibit this property are said to “glow in the dark.” One of the most common sources of excitation is visible light, especially high-energy photons in the U.V. region of the electromagnetic spectrum. A material with luminescent properties excited by visible light is said to be photo-luminescent. Other sources of excitation for producing photo-luminescence include the emission of electrons from x-ray sources as well as the emission of other invisible radiation from the electromagnetic spectrum. Photo-luminescent materials include those materials that may be fluorescent or phosphorescent. The distinction between fluorescent and phosphorescent materials is based on a time scale of light emission. Fluorescent materials emit light on a time scale of less than one microsecond. Phosphorescent materials emit light for substantially longer periods of time. Phosphorescent materials are commonly known as phosphors.

Luminescence may also be excited chemically. A material with luminescent properties excited chemically is said to be chemiluminescent. The source of excitation for chemiluminescent materials is typically from a non-electromagnetic radiation source. For example, with bioluminescent substances, the source of excitation may be an enzyme that catalyzes the reaction and creates an excited state whereby light photons are emitted. This process may be observed in nature, for example, in fireflies and glow worms. Examples of bioluminescent substances are disclosed in U.S. Pat. No. 6,152,358, the disclosure of which is hereby incorporated by reference herein.

### SUMMARY OF THE INVENTION

The present invention is directed to a sanitary paper product for absorbing moisture and having a substance adapted to provide luminescence to at least a portion of the product. In a preferred embodiment of the present invention, luminescent materials, preferably photo-luminescent materials, more preferably phosphors, are combined with a tissue paper product to produce a luminescent tissue product adapted to glow in the dark under reduced light conditions. Preferably, the product will glow for periods lasting from several minutes to many hours. The present invention has numerous useful applications, for example, as facial tissue paper, toilet paper, paper towels, napkins, and other paper products that are ordinarily adapted to absorb moisture. The present invention may also be used as a bio-waste degradation enhancer. Under reduced light conditions, the present invention greatly enhances the user's ability to view and identify the tissue paper product intended to be used by the user.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### DESCRIPTION OF THE PREFERRED EMBODIMENTS

Reference will now be made in detail to the present preferred embodiments (exemplary embodiments) of the invention.

As used herein, the term “sheet” refers to a single, distinct paper web exhibiting the ability to absorb moisture, for example, water.

As used herein, the term “photo-luminescent” is a property of luminescent materials exhibiting the ability to glow after exposure of the luminescent materials to radiation from the electromagnetic spectrum, for example, visible light.

Unless otherwise stated, the present invention will be described in relation to a sanitary paper product such as bathroom tissue or toilet paper, although a person of ordinary skill in the art will appreciate that the present invention is applicable to other tissue paper products in which a degree of absorbency is preferred.

A paper web suitable for use as a bathroom tissue may be made by known methods, such as conventional papermaking through air-dried papermaking, multiple basis weight papermaking, and with a resin-coated forming belt. As part of the above papermaking processes, it is usually desirable to treat the paper web with a temporary wet-strength agent to delay the decay of the tissue paper once exposed to water. Temporary wet-strength agents may be added to the wet end of a wet laid papermaking process, or may be added by spraying or printing the temporary wet strength agent at the dry end of the papermaking process. Exemplary methods for making a paper web suitable for use as a bathroom tissue are disclosed in U.S. Pat. Nos. 6,180,216 and 6,190,499, the disclosures of which are hereby incorporated by reference herein. An example of suitable wet-strength agent for use with tissue products is taught in U.S. Pat. No. 5,656,746, the disclosure of which is incorporated by reference herein. Additionally, other additives, pigments, and dyes may be added at either the wet end or dry end of the papermaking process to confer a degree of softness and add color to the paper web. Such agents may be incorporated into the paper web by coating the outer surface of the web, inter-ply coating of a multi-ply paper web, or by chemically incorporating the coating agent into the web at the time of production. Exemplary methods for applying chemical additives to a paper web are disclosed in U.S. Pat. Nos. 6,126,784 and 6,120,784, the disclosures of which are hereby incorporated by reference herein.

Like other additive agents, luminescent substances may also be incorporated into a paper web using methods such as those described above, the methods being adapted to conform to the chemical properties of additives desired to be used as would be appreciated by one of ordinary skill in the art. Preferably, photo-luminescent substances are used as a luminescent incorporation agent or pigment, and more preferably, phosphorescent phosphors. Most phosphors are inorganic solids resulting from the combination of a metal cation, a nonmetal anion and an activator. Examples of phosphors suitable for use with the present invention include various sulfides, such as zinc sulfide (ZnS) and calcium sulfide (CaS); and SrO.SrAl₄O₇-Eu. Examples of other phosphorescent phosphors are disclosed in U.S. Pat. No. 6,123,871, the disclosure of which is hereby incorporated by reference herein.

Other preferred phosphorescent phosphors which can be utilized and that have extremely long afterglow characteristics include a compound expressed by the matrix MAl₁O₄ in which M is at least one metal element selected from the group consisting of calcium, strontium and barium, or in which M is a plurality of metal elements comprised of magnesium and at least one element selected from the group consisting of calcium, strontium and barium. In a preferred embodiment, 0.001 mol % to 10 mol % of europium may be added to the matrix as an activator, where the mol % is relative to the metal element expressed by M. In another preferred embodiment, 0.001 mol % to 10 mol % of at least one element selected from a group consisting of lanthanium, cerium, praseodymium, neodymium, samarium, gadolinium, terbium, dysprosium, holmium, erbium, thulium, ytterbium, lutetium, manganese, tin and bismuth may be doped to the matrix expressed by MAl₁O₄ as a co-activator in terms of mol % relative to the metal element expressed by M. The preparation of such phosphorescent phosphors is disclosed in U.S. Pat. No. 5,424,006, the disclosure of which is hereby incorporated by reference herein.

Organic phosphors may also be utilized as an incorporation agent or pigment in the present invention. One example of an organic phosphor is the amino acid salt represented by the following formula:

(A_{w}B_{w}MₙXₙYₙ)_{z}

in which A is an amino acid, selected from the class consisting of lysine, ornithine, and diaminopimelic acid, and a group of amino acids with the structure: NH₂(CH₂)ₙCOOH in which n is 1 to 6 (such as n=1: glycine; n=2: beta alanine; n=3: gamma amino butyric acid; n=4: aminovaleric acid; and n=5: 6 aminocaproic acid); B is a carboxylic acid selected from the class consisting of carbonic acid, oxalic acid, and a saturated linear di- or tricarboxylic acid of the structure:

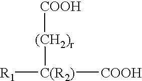

in which r is 0 to 10; R₁ is H, OH or NH₂; R₂ is H, OH, CH₂ COOH, or CH(OH)COOH; w is 1 or 2; n is 0, 1 or 2 and the various n's may be the same or different; M is hydrogen or a metal selected from the Periodic Group IA, such as Li, Na or K, or a metal selected from the Periodic Group IIA, including Mg, Ca, Sr, or Ba, or a metal from Periodic Group IIB, including Zn, and when there are two M's, they may be the same or different; X is a halogen, for example chlorine (Cl) or fluorine (F) or iodine (I); Y is hydroxyl (OH) and Y is greater than X; and z is 1 to 16 formula units.

When r is not zero, then B is a saturated linear dicarboxylic acid, such as succinic, glutaric, adipic, pimelic, malic, glutamic or aspartic acid. When r is zero, then B may be a saturated linear dicarboxylic acid, for example malonic acid, or a saturated linear tricarboxylic acid, for example citric or isocitric acid. The preparation of such organic phosphors is disclosed in U.S. Pat. No. 5,618,467 the disclosure of which is hereby incorporated by reference herein.

Luminescent substances may be combined with the paper web to form patterns and indicia such as symbols and/or text that are attractive to the user. For example, bathroom tissue may have symbols consistent with a holiday theme such as ghost symbols for a Halloween theme, or snowmen for a Christmas theme.

The bathroom tissue of the present invention may be adapted to be dispensed in several ways. For example, the bathroom tissue may be dispensed as a plurality of stacked sheets, or may be dispensed as a plurality of perforated sheets wound around a core. The bathroom tissue of the present invention preferably is adapted to provide a soft texture, which may be achieved in known ways. Additionally, the bathroom tissue is preferably sized to fit known toilet paper dispensers and is preferably less than 12 mm in width when dispensed as a wound core. The bathroom tissue of the present invention may include one to several plies depending upon the quality, softness, durability and material cost desired. In embodiments having multiple plies, luminescent substances may be incorporated into the tissue product to be between the plies and/or around each ply as desired.

The invention is not limited to bathroom tissue and may also be utilized for other products, such as napkins, paper towels, and facial tissue. Additionally, the paper web of the present invention in some embodiments may also be utilized to enhance bio-waste degradation. In such situations where desired, photo-luminescent substances may be added in sufficient quantities to participate in photolysis (photochemical decomposition) of bio-waste that might be retained on the tissue paper after use thereof. Methods of neutralizing bio-waste are disclosed in U.S. Pat. No. 5,736,032, the disclosure of which is hereby incorporated by reference herein.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. A sanitary paper product for absorbing moisture, said product comprising:
a sheet of tissue paper adapted to absorb moisture; and
a substance adapted to provide luminescence to at least a portion of said sheet.

2. The product of claim 1, wherein said substance is a photo-luminescent substance.

3. The product of claim 1, wherein said substance is a phosphorescent phosphor.

4. The product of claim 3, wherein said phosphorescent phosphor is a sulfide phosphorescent phosphor.

5. The product of claim 3, wherein said phosphorescent phosphor is an organic phosphorescent phosphor.

6. The product of claim 1, wherein said substance comprises a compound formed by reacting an amino acid selected from the class consisting of lysine and ornithine with magnesium succinate.

7. The product of claim 1, wherein said substance comprises a compound expressed by the matrix MAl₁O₄ in which M is at least one metal element selected from the group consisting of calcium, strontium and barium, or in which M is a plurality of metal elements comprised of magnesium and at least one element selected from the group consisting of calcium, strontium and barium.

8. The product of claim 1, wherein said luminescent substance forms a pattern on said sheet.

9. The product of claim 1, wherein said luminescent substance forms a plurality of symbols on said sheet.

10. The product of claim 1, wherein said luminescent substance forms text on said sheet.

11. The product of claim 1, wherein said sheet has a plurality of plies.

12. The product of claim 1, wherein said product is adapted to be dispensed as a roll.

13. The product of claim 1, wherein said product is a toilet paper product.

14. The product of claim 13, wherein said sheet has a maximum width of 12 mm.

15. The product of claim 1, wherein said product has a plurality of perforated sheets.

16. The product of claim 1, wherein said product is adapted to be dispensed as a plurality of stacked sheets.

17. The product of claim 1, comprising at least an upper ply and a lower ply, said luminescent substance being between said upper and lower plies.

18. A luminescent toilet tissue product, comprising:
a pigment of a luminescent substance; and
a sheet of toilet tissue adapted to retain said pigment for permitting said sheet to glow in the dark.

19. The toilet tissue product of claim 18, wherein said pigment is a phosphorescent phosphor.

20. The toilet tissue product of claim 19, wherein said phosphorescent phosphor is an organic phosphorescent phosphor.

21. The toilet tissue product of claim 18, wherein said pigment comprises a compound formed by reacting an amino acid selected from the class consisting of lysine and ornithine with magnesium succinate.

22. The toilet tissue product of claim 18, wherein said pigment comprises a compound expressed by the matrix Mal₁O₄ in which M is at least one metal element selected from the group consisting of calcium, strontium and barium, or in which M is a plurality of metal elements comprised of magnesium and at least one element selected from the group consisting of calcium, strontium and barium.

23. The toilet tissue product of claim 18, wherein said sheet has a maximum width of 12 mm.

24. The toilet tissue product of claim 18, wherein said sheet has a plurality of plies.

25. A tissue paper product for allowing easy identification by a user under reduced light conditions, comprising:
a ply of tissue paper, said ply having a web substrate adapted to absorb moisture, said
web substrate having a luminescent substance incorporated therein.

26. A sanitary product, said product comprising:
a combination of a sheet of toilet paper and a luminescent substance, said substance being incorporated in at least a portion of said sheet for allowing easy identification by a user in reduced light conditions.
